(19) United States
(12) Patent Application Publication
(10) Pub. No.: US 2026/0324587 A1
(43) Pub. Date: Oct. 22, 2026

(54) ROTARY DISC FEEDER

(71) Applicant: Fengmei He, Jinggangshan (CN)

(72) Inventor: Fengmei He, Jinggangshan (CN)

(21) Appl. No.: 19/704,617

(22) Filed: Jun. 11, 2026

(51) Int. Cl. A01K 5/02

(52) U.S. Cl. CPC A01K 5/0287; A01K 5/025

(57) ABSTRACT

The present disclosure provides a rotary disc feeder, including a housing, a lid, a rotary disc, a transmission assembly, a can-opening assembly, a first lifting assembly, a second lifting assembly, and an opening-closing assembly. The transmission assembly is arranged to drive the rotary disc to rotate, and through cooperation between the first lifting assembly and the can-opening assembly, a can in each accommodating cavity can sequentially undergo lid opening by the can-opening assembly. Through cooperation between the second lifting assembly and a feeding hole of the lid, the can in each accommodating cavity, after being opened, can be sequentially delivered to the feeding hole of the lid for consumption.

### TECHNICAL FIELD

The present disclosure relates to the technical field of feeders, in particular to a rotary disc feeder.

### BACKGROUND

With the rapid development of the pet keeping industry, automated pet feeders, which can replace manual feeding, can effectively adapt to the fast-paced lifestyle of modern pet owners, avoid the problem of untimely manual feeding, greatly improve the convenience of pet keeping, and thus have now been widely used in home pet keeping scenarios.

Existing automatic canned pet food feeders mostly adopt a fixed large-volume body structure, and are internally integrated with a plurality of groups of transmission and discharging assemblies, a large-capacity storage bin for cans to be consumed, and a storage bin for recycling empty cans, so that functions of sequential storage and automatic discharging of a plurality of cans, as well as recycling of empty cans after consumption are achieved. Existing canned food feeders are bulky in overall device volume, resulting in a large device footprint, and thus, the existing canned food feeders are poorly adaptable to small-sized keeping families, desktops, countertops, and other narrow placement scenarios. Moreover, the existing canned food feeders have complicated storage, pick-and-place, and cleaning processes for cans, a cumbersome device structure makes daily maintenance and residue cleaning difficult, and the overall feeding use process is not convenient enough. Thus, the existing canned food feeders cannot meet the modern pet keeping needs for lightweight, portable, and multi-scenario use.

### SUMMARY

The present disclosure aims to provide a rotary disc feeder, so as to solve the problems proposed in the above background that existing canned food feeders are bulky in overall device volume, resulting in a large device footprint, and thus, the existing canned food feeders are poorly adaptable to small-sized keeping families, desktops, countertops, and other narrow placement scenarios; moreover, the existing canned food feeders have complicated storage, pick-and-place, and cleaning processes for cans, a cumbersome device structure makes daily maintenance and residue cleaning difficult, and the overall feeding use process is not convenient enough.

The technical solution adopted by the present disclosure to solve the technical problems is as follows. A rotary disc feeder includes a housing, a lid, a rotary disc, a transmission assembly, a can-opening assembly, a first lifting assembly, a second lifting assembly, and an opening-closing assembly; the lid is arranged on the housing in a manner of being openable and closable, the rotary disc is rotatably arranged in the housing and provided with a plurality of accommodating cavities each having an open hole at a bottom end, and the lid is provided with a feeding hole corresponding to a top end of one of the accommodating cavities; the transmission assembly is arranged in the housing and is in transmission connection with the rotary disc, and the can-opening assembly is arranged in the lid and extends on a bottom end surface of the lid to correspond to the top end of one of the accommodating cavities; and the first lifting assembly is arranged in the housing and correspondingly located at a bottom end of the rotary disc, the second lifting assembly is arranged in the housing and correspondingly located at the bottom end of the rotary disc, and the opening-closing assembly is arranged on the lid and configured to cover or expose the feeding hole in the lid.

In some embodiments, the rotary disc feeder further includes an RFID sensing assembly, the RFID sensing assembly is arranged in the lid and includes a processing circuit board and an RFID sensing coil, and the processing circuit board is electrically connected to the RFID sensing coil.

In some embodiments, the opening-closing assembly is arranged in the lid and extends on the bottom end surface of the lid to correspond to the feeding hole, and the opening-closing assembly includes a first motor, a first gear a, a support plate, a rotating shaft, a first gear b, and a baffle plate; the first motor is fixed in the lid, the first gear a is connected to an output end of the first motor and rotatably arranged in the lid, the support plate is fixed in the lid, and the rotating shaft is rotatably connected to a bottom end of the support plate; and the first gear b and the rotating shaft are integrally formed, the first gear a is in engaged connection with the first gear b, the baffle plate is in screwed connection with a bottom end of the rotating shaft and is located on the bottom end surface of the lid, the baffle plate corresponds to the feeding hole in the lid, and a side part of the baffle plate is provided with a soft rubber portion.

In some embodiments, the housing has an inner frame inside, the rotary disc is rotatably arranged in the inner frame, and the transmission assembly, the first lifting assembly, and the second lifting assembly are distributed and fixed on a bottom end surface of the inner frame.

In some embodiments, a top end of the inner frame has a boss, the boss is provided with a ring groove, the bottom end of the rotary disc has a ring block, and the ring block at the bottom end of the rotary disc is movably located in the ring groove of the boss; the boss is internally provided with an accommodating groove, the boss is provided with a bearing groove within the accommodating groove, the accommodating groove has a second gear b inside, a bottom end of the second gear b is equipped with a support bearing, and the support bearing at the bottom end of the second gear b is correspondingly located in the bearing groove; a top end of the second gear b is provided with a polygonal slot, the polygonal slot is exposed on an outer surface part of the boss, the bottom end of the rotary disc is provided with a polygonal insertion rod, and the polygonal insertion rod at the bottom end of the rotary disc is inserted into the polygonal slot at the top end of the second gear b; and the transmission assembly includes a second motor and a second gear a, the second motor is fixed on the bottom end surface of the inner frame, an output shaft end of the second motor extends to be located in the accommodating groove of the boss, the second gear a is located in the accommodating groove of the boss and fixed to the output shaft end of the second motor, and the second gear a is in engaged connection with the second gear b.

In some embodiments, the can-opening assembly includes a first bracket, a third motor, a third gear a, a third gear b, a third gear c, a third gear d, a third gear e, a third gear f, a third gear g, a third gear h, a rotator, a driven member, a displacement plate, a cutting blade, an abutting gear, and an edge-abutting plate; the third motor is fixed on an inner side of the first bracket, the third gear a is fixed at an output shaft end of the third motor, the third gear b is rotatably arranged on the inner side of the first bracket, the third gear a is in engaged connection with the third gear b, the third gear c is fixed at a bottom end of the third gear b, the third gear d is rotatably arranged on the inner side of the first bracket, and the third gear c is in engaged connection with the third gear d; the third gear e is fixed at a top end of the third gear d, the third gear f is rotatably arranged on the inner side of the first bracket, the third gear e is in engaged connection with the third gear f, the third gear g is fixed at a top end of the third gear f, the third gear h is rotatably arranged on the inner side of the first bracket, the third gear g is in engaged connection with the third gear h, and a plurality of sleeve holes are annularly distributed in a bottom end of the third gear h; a top end of the rotator is provided with an accommodating frame, the abutting block is elastically connected in the accommodating frame, the abutting block at the top end of the rotator is correspondingly located in one of the sleeve holes, one side of a top end of the abutting block is arranged as a slope surface, and the other side of the top end of the abutting block is arranged as an inclined groove; the inner side of the first bracket is provided with a circular cavity, one half of the circular cavity is a sector-shaped closed cavity, and the other half of the circular cavity is a sector-shaped open cavity; the rotator is rotatably located in the circular cavity, one end of the circular cavity within the sector-shaped open cavity is provided with a squeezing block, a front end of the squeezing block is arranged as an inclined surface, the first bracket is provided with a vertically-through hollow cylinder at a position correspondingly located in a middle part of the circular cavity, a bearing body is fixed in the hollow cylinder, a bottom end of the rotator has an eccentric wheel, the driven member is located on the inner side of the first bracket, and one end of the driven member is provided with an abutting hole; the eccentric wheel is correspondingly located in the abutting hole and abuts against an inner wall of the abutting hole, a bottom end surface of the first bracket is provided with a displacement-allowing groove, and the displacement plate is correspondingly located in the displacement-allowing groove; a top end of the displacement plate is provided with a ring edge extending to be located on the inner side of the first bracket, the other end of the driven member is provided with a sleeve groove sleeving the ring edge, the cutting blade is rotatably arranged at a bottom end of the displacement plate, and a central shaft penetrating through the bearing body, the rotator, the driven member, and the displacement plate is fixed to a middle part of the third gear h; and the abutting gear is fixed at a bottom end of the central shaft and correspondingly located at the bottom end of the displacement plate, the edge-abutting plate sleeves the central shaft and is correspondingly located between the displacement plate and the abutting gear, and a bottom end of the edge-abutting plate is provided with a cambered protruding edge in contact with a top end of the abutting gear.

In some embodiments, the first lifting assembly includes a second bracket, a fourth motor, and a lifting base, the second bracket is fixed on the bottom end surface of the inner frame, the fourth motor is fixed at a bottom end of the second bracket, an output end of the fourth motor has a first lead screw shaft, the lifting base is in threaded connection with the first lead screw shaft, the lifting base penetrates through the inner frame to correspond to the open hole at the bottom end of one of the accommodating cavities, a plurality of guide grooves are distributed in the second bracket, a plurality of guide columns are distributed on the lifting base, and each of the guide columns is movably located in the corresponding guide groove.

In some embodiments, the second lifting assembly includes a third bracket, a fifth motor, a lifting platform, a weighing sensor, and a semiconductor refrigerator; and the third bracket is fixed on the bottom end surface of the inner frame, the fifth motor is fixed onto the third bracket, an output end of the fifth motor has a second lead screw shaft, the lifting platform is in threaded connection with the second lead screw shaft, the third bracket is provided with a slide rail corresponding to a side part of the lifting platform, the lifting platform is further slidably connected to the slide rail, the weighing sensor is fixed to the side part of the lifting platform, the semiconductor refrigerator is fixed onto the weighing sensor, and the semiconductor refrigerator penetrates through the inner frame to correspond to the open hole at the bottom end of one of the accommodating cavities.

In some embodiments, the semiconductor refrigerator includes a lifting frame, a semiconductor refrigeration sheet, a heat dissipation fin, and an electric fan; and the semiconductor refrigeration sheet is fixed on an inner top of the lifting frame, the electric fan is fixed on an inner bottom of the lifting frame, the heat dissipation fin is fixed between the semiconductor refrigeration sheet and the electric fan, a top surface of the semiconductor refrigeration sheet is in contact with an inner top surface of the lifting frame, and a ventilation hole corresponding to the electric fan is formed in a bottom end of the lifting frame.

In some embodiments, one side of the lid and one side of the housing are connected by a rotating shaft, and a latch assembly is arranged between the other side of the lid and the other side of the housing; the latch assembly includes a support post, a spring, a push button, a buckle plate, and guide rods; the support post is fixed on an outer surface part of the inner frame, the spring is fixed on the outer surface part of the inner frame and surrounds the support post, the push button is fixed on the spring and extends to be located on an outer surface part of the housing, the buckle plate is integrally formed at a top end of the push button, and a buckle wall is arranged on one side of a top end of the buckle plate; the lid is internally provided with a movement-allowing groove, a side part of the movement-allowing groove is provided with an opening, the top end of the buckle plate extends to be located in the movement-allowing groove, and the buckle wall at the top end of the buckle plate corresponds to the opening; and two guide rods are provided, the two guide rods are symmetrically arranged on the outer surface part of the inner frame, two sides of the push button are both provided with arc-shaped grooves, and the arc-shaped grooves in the two sides of the push button respectively accommodate the two guide rods.

Compared with the prior art, the present disclosure has the following beneficial effects. In the present disclosure, by arranging the transmission assembly to drive the rotary disc to rotate, and through the cooperation between the first lifting assembly and the can-opening assembly, a can in each accommodating cavity of the rotary disc can sequentially undergo lid opening by the can-opening assembly; and furthermore, through the cooperation between the second lifting assembly and the feeding hole of the lid, the can in each accommodating cavity of the rotary disc, after being opened, can be sequentially delivered to the feeding hole of the lid for consumption. The rotary disc feeder is compact in size, convenient to carry, and easy to clean and maintain, and has the advantage of convenient use.

### BRIEF DESCRIPTION OF THE DRAWINGS

FIG. 1 is an overall schematic structural diagram of a rotary disc feeder.

FIG. 2 is a schematic structural diagram of a rotary disc feeder with a lid in an open state.

FIG. 3 is a schematic structural diagram of a rotary disc feeder in a state where a can is placed inside.

FIG. 4 is a schematic structural diagram of a rotary disc feeder with a lid and a housing in a separated state.

FIG. 5 is a schematic exploded view of a rotary disc feeder from a top perspective.

FIG. 6 is a schematic exploded view of a rotary disc feeder from a bottom perspective.

FIG. 7 is a schematic structural diagram of an inner frame and a rotary disc in a sectional state.

FIG. 8 is a schematic structural diagram of an inner frame, a transmission assembly, and a rotary disc in a separated state.

FIG. 9 is an overall schematic structural diagram of a first lifting assembly.

FIG. 10 is a schematic exploded view of a first lifting assembly.

FIG. 11 is an overall schematic structural diagram of a second lifting assembly.

FIG. 12 is a schematic structural diagram of a lifting frame and a semiconductor refrigerator in a separated state.

FIG. 13 is a schematic structural diagram of a lid in a state where its interior is open.

FIG. 14 is a schematic structural diagram of a lid from a bottom perspective.

FIG. 15 is an overall schematic structural diagram of an opening-closing assembly.

FIG. 16 is a schematic structural diagram of a first bracket in a can-opening assembly in a separated state.

FIG. 17 is an overall schematic structural diagram of a can-opening assembly.

FIG. 18 is a schematic structural diagram of an edge-abutting plate and a can-abutting plate in a can-opening assembly in a separated state.

FIG. 19 is a schematic exploded view of a can-opening assembly from a first perspective.

FIG. 20 is a schematic exploded view of a can-opening assembly from a second perspective.

FIG. 21 is a schematic structural diagram of an eccentric wheel and a driven member in an assembled state.

FIG. 22 is a schematic structural diagram of an eccentric wheel and a displacement plate in an assembled state.

FIG. 23 is a schematic structural diagram of a can-opening assembly and a can in a cooperated state.

FIG. 24 is a schematic structural diagram of a housing, a rotator, and a third gear h.

FIG. 25 is a schematic structural diagram of a rotary disc feeder with a lid and a housing in a separated state.

FIG. 26 is an enlarged schematic structural diagram of a position A in FIG. 25.

FIG. 27 is a schematic structural diagram of a rotary disc feeder with a lid, a housing and a latch assembly in a separated state.

FIG. 28 is an enlarged schematic structural diagram of a position B in FIG. 27.

Reference Numerals: 1000, Rotary disc feeder; 10, Housing; 20, Lid; 201, Feeding hole; 202, Movement-allowing groove; 2021, Opening; 30, Inner frame; 301, Boss; 3011, Ring groove; 3012, Accommodating groove; 30121, Bearing groove; 3013, Second gear b; 30131, Support bearing; 30132, Polygonal slot; 40, Rotary disc; 401, Accommodating cavity; 4011, Open hole; 402, Ring block; 403, Polygonal insertion rod; 50, Transmission assembly; 501, Second motor; 502, Second gear a; 60, Can-opening assembly; 601, First bracket; 6011, Hollow cylinder; 60111, Bearing body; 6012, Displacement-allowing groove; 6013, Circular cavity; 60131, Sector-shaped closed cavity; 60132, Sector-shaped open cavity; 6014, Squeezing block; 60141, Inclined surface; 602, Third motor; 603, Third gear a; 604, Third gear b; 605, Third gear c; 606, Third gear d; 607, Third gear e; 608, Third gear f; 609, Third gear g; 610, Third gear h; 6101, Central shaft; 6102, Sleeve hole; 611, Rotator; 6111, Accommodating frame; 6112, Abutting block; 61121, Slope surface; 61122, Inclined groove; 612, Eccentric wheel; 613, Driven member; 6131, Abutting hole; 6132, Sleeve groove; 614, Displacement plate; 6141, Ring edge; 6142, Elliptical hole; 615, Cutting blade; 616, Abutting gear; 617, Edge-abutting plate; 6171, Cambered protruding edge; 70, First lifting assembly; 701, Second bracket; 7011, Guide groove; 702, Fourth motor; 703, First lead screw shaft; 704, Lifting base; 7041, Guide column; 80, Second lifting assembly; 801, Third bracket; 8011, Slide rail; 802, Fifth motor; 803, Second lead screw shaft; 804, Lifting platform; 805, Weighing sensor; 806, Semiconductor refrigerator; 8061, Lifting frame; 8062, Semiconductor refrigeration sheet; 8063, Heat dissipation fin; 8064, Electric fan; 90, Opening-closing assembly; 901, First motor; 902, First gear a; 903, Support plate; 904, Rotating shaft; 905, First gear b; 906, Baffle plate; 9061, Soft rubber portion; 9062, Side edge; 100, RFID sensing assembly; 1001, Processing circuit board; 1002, RFID sensing coil; 110, Latch assembly; 1101, Support post; 1102, Spring; 1103, Push button; 11031, Arc-shaped groove; 1104, Buckle plate; 11041, Buckle wall; 1105, Guide rod; 2000, Can; and 20001, Ring wall.

### DETAILED DESCRIPTION OF EMBODIMENTS

The technical solutions in embodiments of the present disclosure will be described below clearly and completely with reference to accompanying drawings in the embodiments of the present disclosure. Apparently, the described embodiments are only part of the embodiments of the present disclosure, but not all the embodiments. Based on the embodiments in the present disclosure, all other embodiments obtained by a person of ordinary skill in the art without making creative efforts shall fall within the scope of protection of the present disclosure.

In addition, descriptions referring to “first”, “second”, etc. in the present disclosure are only used for descriptive purposes, and cannot be understood as indicating or implying relative importance or implicitly indicating the quantity of the indicated technical features. Therefore, the features defined by “first” and “second” may explicitly or implicitly include at least one of the features.

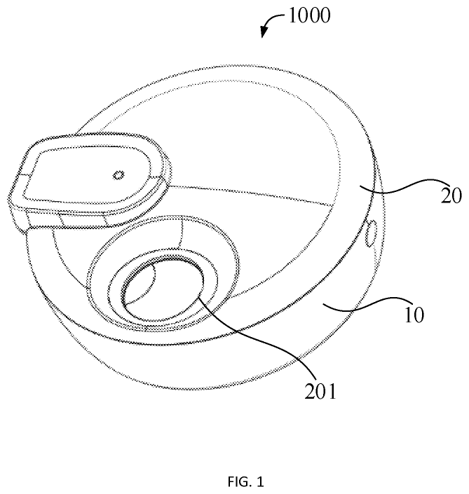

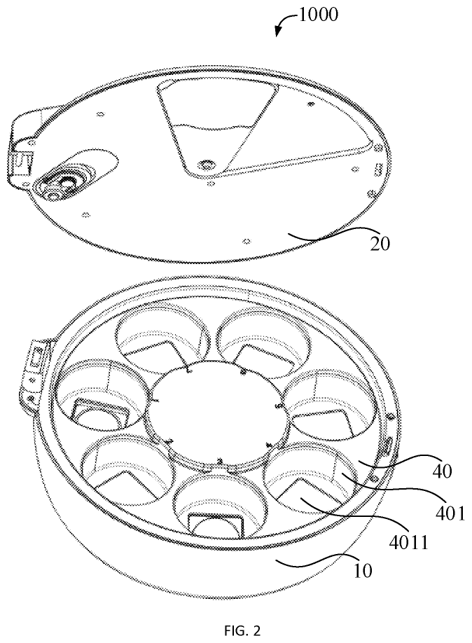

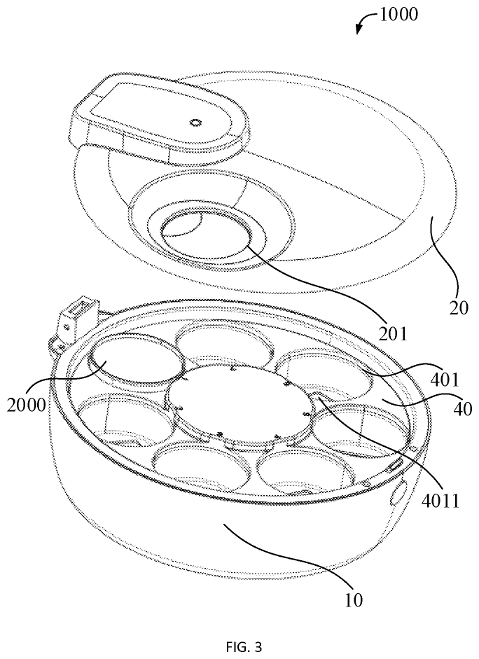

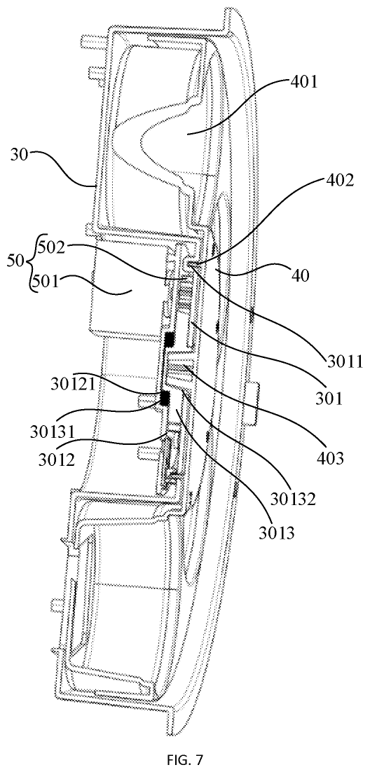

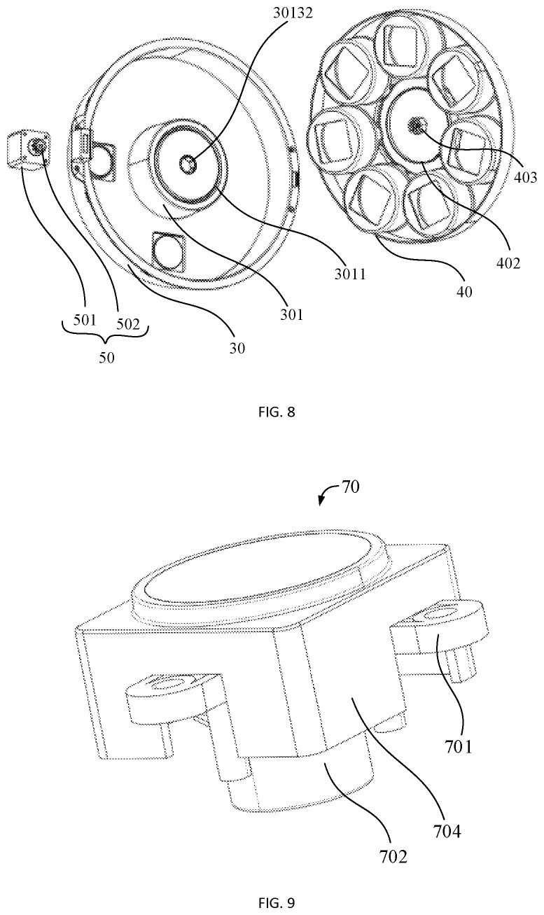

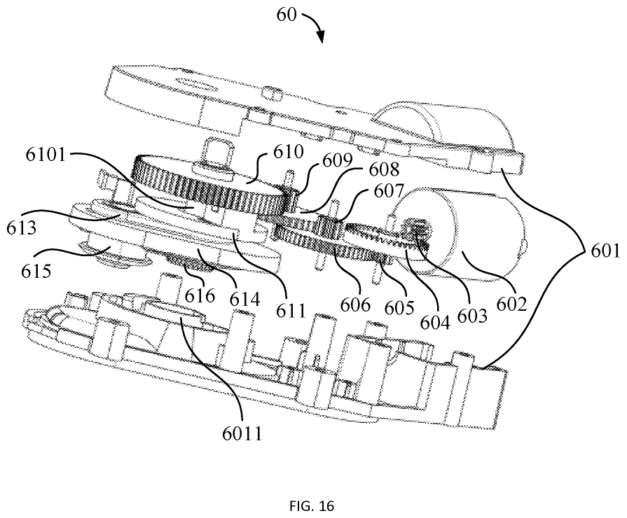

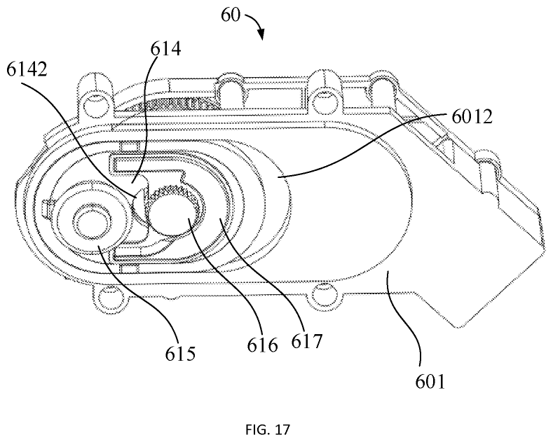

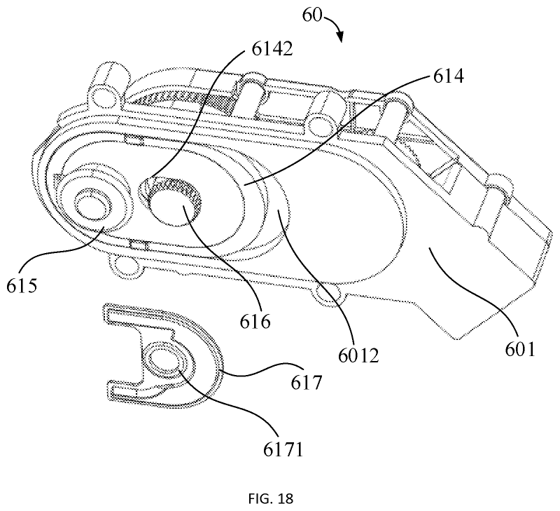

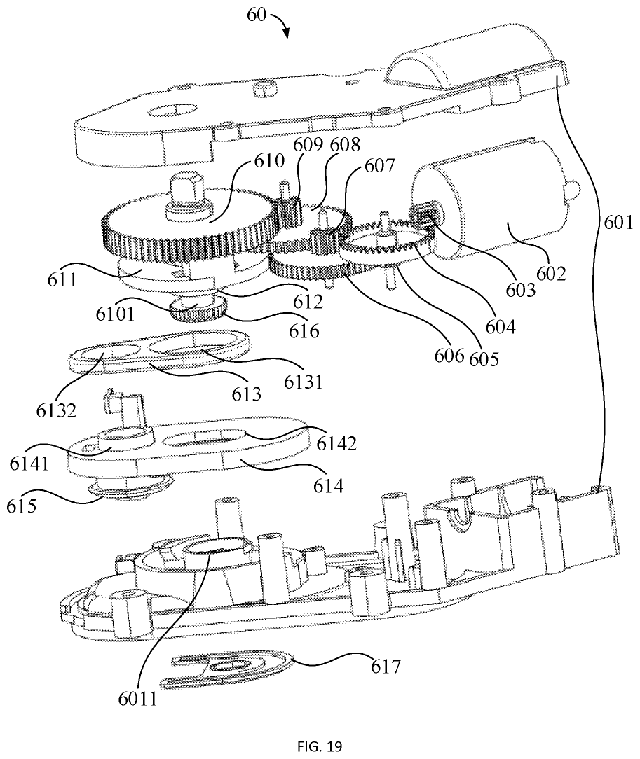

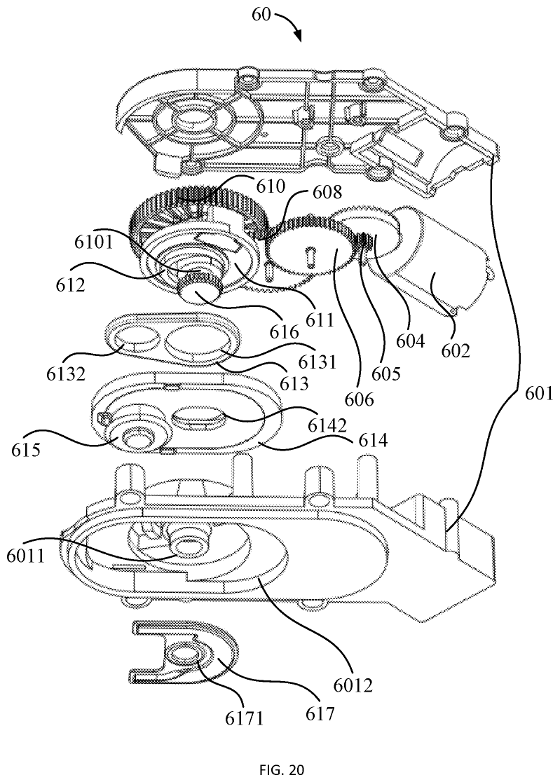

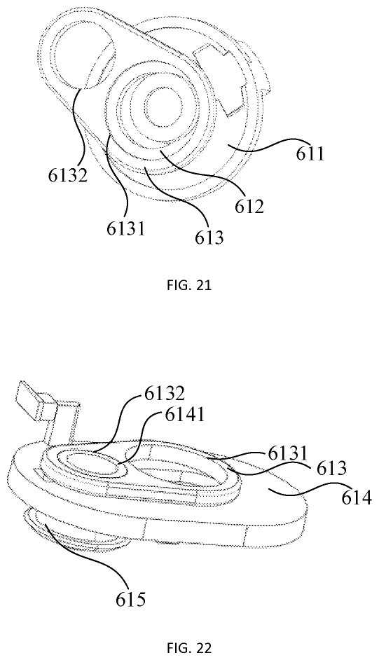

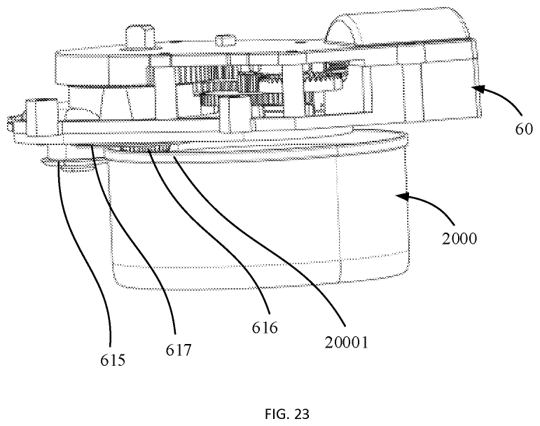

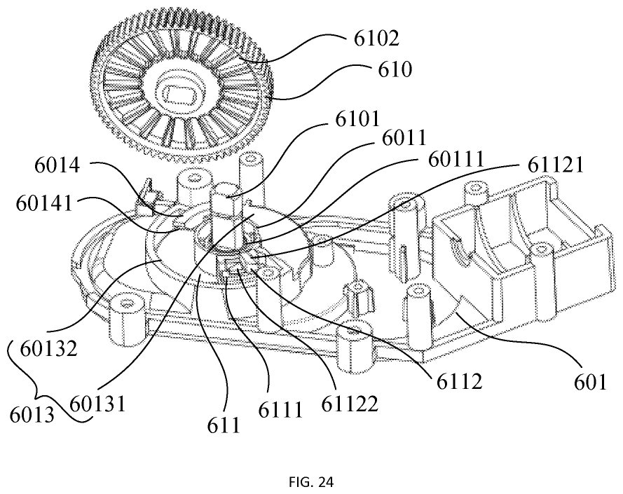

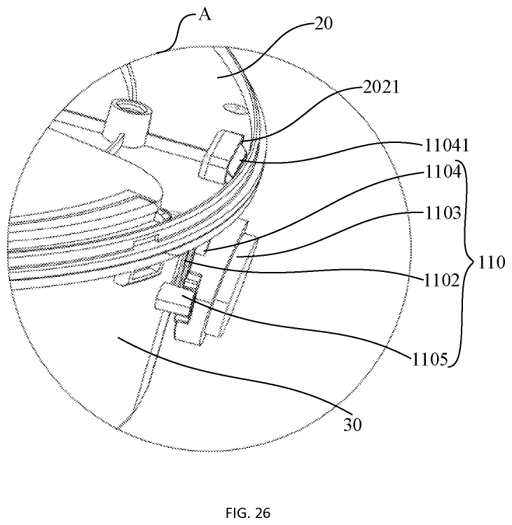

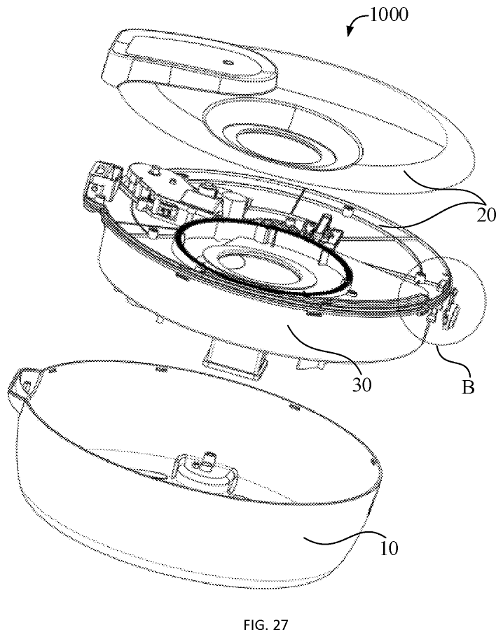

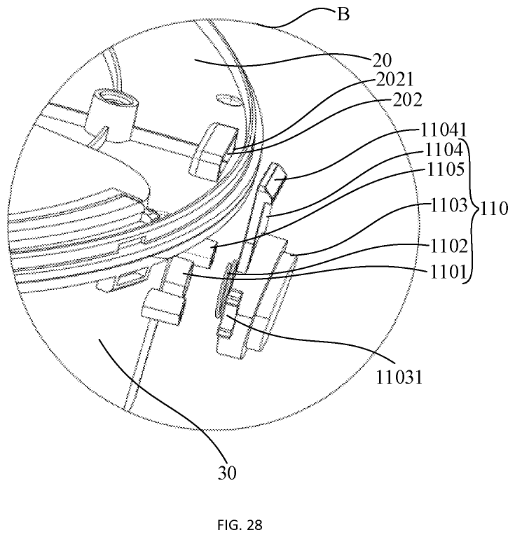

Referring to FIG. 1 to FIG. 28, the present disclosure provides the following technical solutions. A rotary disc feeder 1000 includes a housing 10, a lid 20, a rotary disc 40, a transmission assembly 50, a can-opening assembly 60, a first lifting assembly 70, a second lifting assembly 80, and an opening-closing assembly 90. The lid 20 is arranged on the housing 10 in a manner of being openable and closable, the rotary disc 40 is rotatably arranged in the housing 10 and provided with a plurality of accommodating cavities 401 each having an open hole 4011 at a bottom end, and the lid 20 is provided with a feeding hole 201 corresponding to a top end of one of the accommodating cavities 401. The transmission assembly 50 is arranged in the housing 10 and is in transmission connection with the rotary disc 40, and the can-opening assembly 60 is arranged in the lid 20 and extends on a bottom end surface of the lid 20 to correspond to the top end of one of the accommodating cavities 401. The first lifting assembly 70 is arranged in the housing 10 and correspondingly located at a bottom end of the rotary disc 40, the second lifting assembly 80 is arranged in the housing 10 and correspondingly located at the bottom end of the rotary disc 40, and the opening-closing assembly 90 is arranged on the lid 20 and configured to cover or expose the feeding hole 201 in the lid 20.

In the rotary disc feeder 1000 provided by this embodiment, a user may open the lid 20 on the housing 10, then place a plurality of cans 2000 respectively into the accommodating cavities 401 of the rotary disc 40, and then close the lid 20 on the housing 10. When a pet is about to eat food, the transmission assembly 50 in the housing 10 drives the rotary disc 40 to rotate counterclockwise, so that a can in one of the accommodating cavities 401 in the rotary disc 40 corresponds to a position above the first lifting assembly 70 and a position below the can-opening assembly 60. Since the position of the can-opening assembly 60 corresponds vertically and linearly to the position of the first lifting assembly 70, the can in the accommodating cavity 401 may simultaneously correspond to the position above the first lifting assembly 70 and the position below the can-opening assembly 60. Then, the first lifting assembly 70 is actuated and embedded into the accommodating cavity 401 from the open hole 4011 in the bottom end of the accommodating cavity 401 to lift the can. The can-opening assembly 60 then cuts off a can lid of the corresponding can and grips the can lid. The first lifting assembly 70 descends inside the accommodating cavity 401 to drive the can whose can lid has been cut to be placed back into the accommodating cavity 401, and then the first lifting assembly 70 descends inside the accommodating cavity 401 to withdraw. After the can in the accommodating cavity 401 has been opened, the transmission assembly 50 in the housing 10 drives the rotary disc 40 to continue rotating counterclockwise, so that the can whose can lid has been cut in the accommodating cavity 401 corresponds to a position above the second lifting assembly 80 and a position below the feeding hole 201 of the lid 20. Since the position of the feeding hole 201 of the lid 20 corresponds vertically and linearly to the position of the second lifting assembly 80, the can whose can lid has been cut in the accommodating cavity 401 may simultaneously correspond to the position above the second lifting assembly 80 and the position below the feeding hole 201 of the lid 20. Then, the opening-closing assembly 90 operates to open the feeding hole 201 in the lid 20, and the second lifting assembly 80 is then actuated and embedded into the accommodating cavity 401 from the open hole 4011 in the bottom end of the accommodating cavity 401, so as to lift the can whose can lid has been cut to correspond to the feeding hole 201 of the lid 20, so that the pet can eat the food inside the can through the feeding hole 201 of the lid 20. When the pet has eaten up the food inside the can, and the second lifting assembly 80 recognizes, through a weighing function, that the can reaches a weight indicating that the food has been consumed, the second lifting assembly 80 is actuated to descend inside the accommodating cavity 401, so as to drive the empty can to be placed back into the accommodating cavity 401, and the second lifting assembly 80 then descends inside the accommodating cavity 401 to withdraw. At this point, the transmission assembly 50 in the housing 10 drives the rotary disc 40 to rotate clockwise. As the rotary disc 40 rotates clockwise, the empty can in that accommodating cavity 401 is driven to correspond to the position above the first lifting assembly 70 and the position below the can-opening assembly 60. Then, the first lifting assembly 70 is actuated and embedded into the accommodating cavity 401 from the open hole 4011 in the bottom end of the accommodating cavity 401, so that the first lifting assembly 70 lifts the empty can in that accommodating cavity 401 to receive the previously gripped can lid released by the can-opening assembly 60. Thereafter, the first lifting assembly 70 is actuated to descend inside the accommodating cavity 401, so as to drive the empty can receiving the can lid to be placed back into the accommodating cavity 401, and the first lifting assembly 70 then descends inside the accommodating cavity 401 to withdraw. Then, the transmission assembly 50 operates to drive the rotary disc 40 to rotate counterclockwise. As the rotary disc 40 rotates counterclockwise, the empty can carrying the can lid in that accommodating cavity 401 is driven to rotate downward to avoid the positions of the can-opening assembly 60 and the position of the feeding hole 201, so as to make way for to-be-consumed cans in other accommodating cavities 401 on the rotary disc 40 to be sequentially rotated to the can-opening assembly 60 for opening, and after being opened, to be sequentially rotated to the feeding hole 201 of the lid 20 for consumption by the pet. When the pet has eaten only a part of the food inside the can instead of finishing it completely, and the second lifting assembly 80 recognizes, through the weighing function, that the weight of the can does not reach the weight indicating that the food has been completely consumed, the second lifting assembly 80 drives the can to descend partially inside the accommodating cavity 401, and the opening-closing assembly 90 closes the feeding hole 201 of the lid 20. The opening-closing assembly 90 uses a baffle plate 906 to cover the feeding hole 201 of the lid 20, and an opening of the can is precisely aligned with the baffle plate 906 of the opening-closing assembly 90 and is covered by the baffle plate. Additionally, the second lifting assembly 80 also has a refrigeration function. The second lifting assembly 80 with refrigeration being activated can emit cold energy to make contact with the can, so that the can, while being closed by the opening-closing assembly 90 inside the accommodating cavity 401, can still be kept fresh by refrigeration, waiting for the pet to continue eating the remaining food in the can when it comes next time. In the present disclosure, by arranging the transmission assembly 50 to drive the rotary disc 40 to rotate, and through the cooperation between the first lifting assembly 70 and the can-opening assembly 60, the can 2000 in each accommodating cavity 401 of the rotary disc 40 can sequentially undergo lid opening by the can-opening assembly 60; and furthermore, through the cooperation between the second lifting assembly 80 and the feeding hole 201 of the lid 20, the can 2000 in each accommodating cavity 401 of the rotary disc 40, after being opened, can be sequentially delivered to the feeding hole 201 of the lid 20 for consumption. The rotary disc feeder 1000 is compact in size, convenient to carry, and easy to clean and maintain, and has the advantage of convenient use.

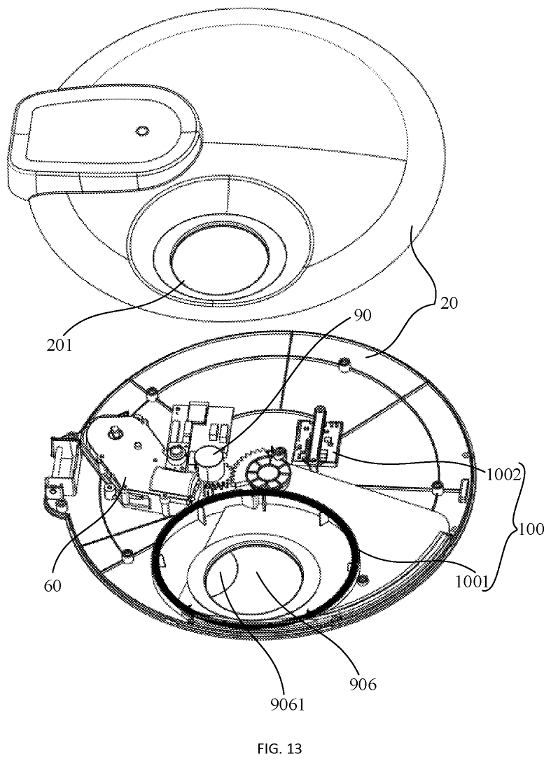

Referring primarily to FIG. 13, in some embodiments, the rotary disc feeder 1000 further includes an RFID sensing assembly 100, the RFID sensing assembly 100 is arranged in the lid 20 and includes a processing circuit board 1001 and an RFID sensing coil 1002, and the processing circuit board 1001 is electrically connected to the RFID sensing coil 1002.

During specific implementation, when using the rotary disc feeder 1000, the user may have the pet wear an RFID electronic tag. When the pet approaches the rotary disc feeder 1000, the RFID sensing assembly 100 senses the RFID electronic tag of the pet to recognize the pet's identity. After the pet's identity is verified, the opening-closing assembly 90, according to a pet arrival signal fed back by the RFID sensing assembly 100, opens the feeding hole 201 of the lid 20, thereby exposing the opened can in the accommodating cavity 401 corresponding to the feeding hole 201 for the pet to eat. Moreover, when the pet leaves the rotary disc feeder 1000, the RFID sensing assembly 100 cannot sense the RFID electronic tag of the pet. Accordingly, the opening-closing assembly 90 closes the feeding hole 201 of the lid 20 according to a signal indicating that the pet has left recognized by the RFID sensing assembly 100. When the RFID sensing assembly 100 is in operation, the RFID sensing coil 1002 detects whether the pet's RFID electronic tag is electromagnetically sensed or not, and the processing circuit board 1001 then recognizes the arrival or departure of the pet according to the sensing feedback from the RFID sensing coil 1002. Through such arrangement, the RFID sensing assembly 100 can effectively sense the arrival and departure of the pet, so that the opening-closing assembly 90 controls the opening or closing of the feeding hole 201 of the lid 20 according to the signal fed back by the RFID sensing assembly 100.

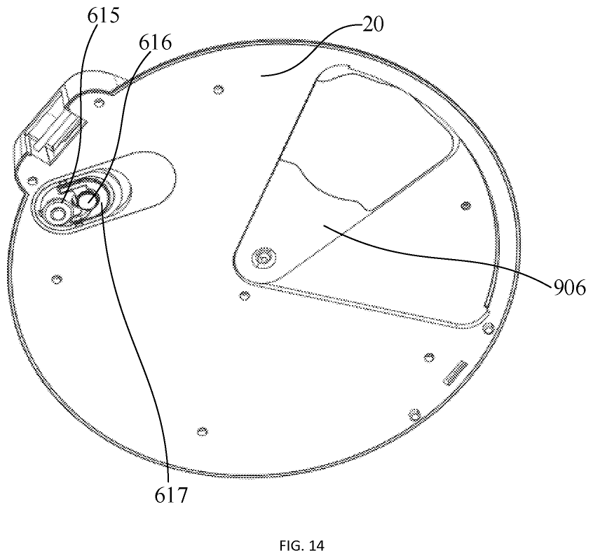

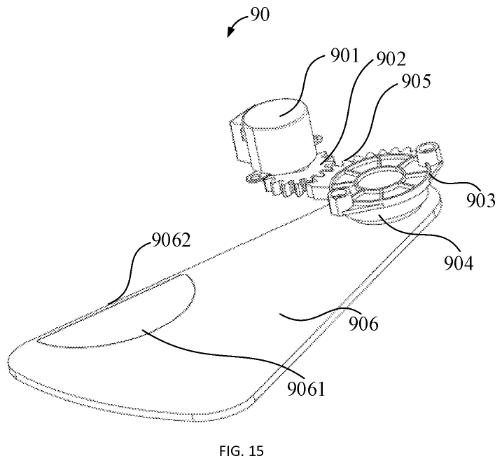

Referring primarily to FIG. 14 and FIG. 15, in some embodiments, the opening-closing assembly 90 is arranged in the lid 20 and extends on the bottom end surface of the lid 20 to correspond to the feeding hole 201, and the opening-closing assembly 90 includes a first motor 901, a first gear a 902, a support plate 903, a rotating shaft 904, a first gear b 905, and a baffle plate 906. The first motor 901 is fixed in the lid 20, the first gear a 902 is connected to an output end of the first motor 901 and rotatably arranged in the lid 20, the support plate 903 is fixed in the lid 20, and the rotating shaft 904 is rotatably connected to a bottom end of the support plate 903. The first gear b 905 and the rotating shaft 904 are integrally formed, the first gear a 902 is in engaged connection with the first gear b 905, the baffle plate 906 is in screwed connection with a bottom end of the rotating shaft 904 and is located on the bottom end surface of the lid 20, the baffle plate 906 corresponds to the feeding hole 201 in the lid 20, and a side part of the baffle plate 906 is provided with a soft rubber portion 9061.

During specific implementation, when the opening-closing assembly 90 opens or closes the feeding hole 201 in the lid 20, the first motor 901 drives the first gear a 902 to rotate counterclockwise or clockwise. When the first gear a 902 rotates, the first gear b 905 is driven to rotate. Since the first gear b 905 and the rotating shaft 904 are integrally formed, the first gear b 905 and the rotating shaft 904 rotate at the bottom end of the support plate 903. As the rotating shaft 904 rotates, the baffle plate 906 at the bottom end is also driven to rotate counterclockwise or clockwise. Thus, when rotating counterclockwise, the baffle plate 906 moves away from the bottom end of the feeding hole 201 to open the feeding hole 201, or when rotating clockwise, the baffle plate 906 is correspondingly located exactly at the bottom end of the feeding hole 201 to cover the feeding hole 201. When a pet not wearing an RFID electronic tag or a pet wearing an electronic tag but with an unmatched identity comes to the feeding hole 201 of the lid 20 to eat, since the RFID sensing assembly 100 cannot sense the RFID electronic tag matching the pet's identity, the opening-closing assembly 90 closes the feeding hole 201. When the opening-closing assembly 90 covers the feeding hole 201 with the baffle plate 906, to prevent pinching the pet, the side part of the baffle plate 906 has the soft rubber portion 9061. The soft rubber portion 9061 is made of a soft material (such as silicone or rubber). Thus, when the baffle plate 906 makes contact with the pet, a side edge 9062 of the baffle plate 906 is broken by the pet (because a width of the side edge 9062 is set to be narrower). When the side edge 9062 of the baffle plate 906 is broken, the soft rubber portion 9061 on the side part of the baffle plate 906 makes soft contact with the pet. The soft rubber portion 9061 can be compressed, thereby preventing the pet from being pinched and avoiding harm to the pet. The baffle plate 906 is a quick-wear part. The baffle plate 906 is connected to the bottom end of the rotating shaft 904 by screws, so that the baffle plate 906 can be demounted and mounted on the rotating shaft 904, facilitating replacement of the baffle plate 906. Through such arrangement, the opening-closing assembly 90 can effectively achieve opening or closing of the feeding hole 201 in the lid 20.

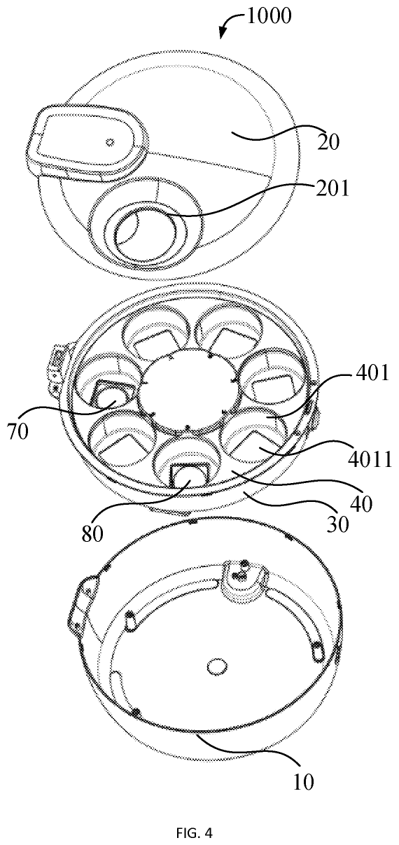

Referring primarily to FIG. 4 to FIG. 6, in some embodiments, the housing 10 has an inner frame 30 inside, the rotary disc 40 is rotatably arranged in the inner frame 30, and the transmission assembly 50, the first lifting assembly 70, and the second lifting assembly 80 are distributed and fixed on a bottom end surface of the inner frame 30.

During specific implementation, the inner frame 30 inside the housing 10 is configured to support the rotary disc 40. The transmission assembly 50 is fixed on the bottom end surface of the inner frame 30, so that the transmission assembly 50 can be fixed onto the inner frame 30 to drive the rotary disc 40 to rotate within the inner frame 30. The first lifting assembly 70 is fixed on the bottom end surface of the inner frame 30, and the inner frame 30 is provided with a hole corresponding to the first lifting assembly 70, so that when operating, the first lifting assembly 70 can movably extend to an inner top side of the inner frame 30. Thus, the first lifting assembly 70 can be fixed onto the inner frame 30 and correspondingly embedded into the accommodating cavities 401 of the rotary disc 40 to lift the cans, so that the cans undergo lid opening by the can-opening assembly 60. The second lifting assembly 80 is fixed on the bottom end surface of the inner frame 30, and the inner frame 30 is provided with a hole corresponding to the second lifting assembly 80, so that when operating, the second lifting assembly 80 can movably extend to the inner top side of the inner frame 30. Thus, the second lifting assembly 80 can be fixed onto the inner frame 30 and correspondingly embedded into the accommodating cavities 401 of the rotary disc 40 to lift the opened cans, so that the opened cans are made to correspond to the feeding hole 201 of the lid 20 for the pet to eat. Through such arrangement, the transmission assembly 50, the first lifting assembly 70, and the second lifting assembly 80 can all be fixed onto the inner frame 30 for application.

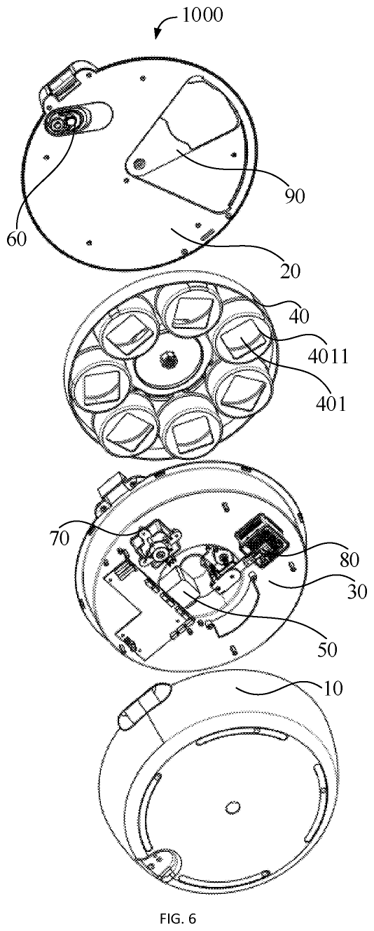

Referring primarily to FIG. 6 to FIG. 8, in some embodiments, a top end of the inner frame 30 has a boss 301, the boss 301 is provided with a ring groove 3011, the bottom end of the rotary disc 40 has a ring block 402, and the ring block 402 at the bottom end of the rotary disc 40 is movably located in the ring groove 3011 of the boss 301. The boss 301 is internally provided with an accommodating groove 3012, the boss 301 is provided with a bearing groove 30121 within the accommodating groove 3012, the accommodating groove 3012 has a second gear b 3013 inside, a bottom end of the second gear b 3013 is equipped with a support bearing 30131, and the support bearing 30131 at the bottom end of the second gear b 3013 is correspondingly located in the bearing groove 30121. A top end of the second gear b 3013 is provided with a polygonal slot 30132, the polygonal slot 30132 is exposed on an outer surface part of the boss 301, the bottom end of the rotary disc 40 is provided with a polygonal insertion rod 403, and the polygonal insertion rod 403 at the bottom end of the rotary disc 40 is inserted into the polygonal slot 30132 at the top end of the second gear b 3013. The transmission assembly 50 includes a second motor 501 and a second gear a 502, the second motor 501 is fixed on the bottom end surface of the inner frame 30, an output shaft end of the second motor 501 extends to be located in the accommodating groove 3012 of the boss 301, the second gear a 502 is located in the accommodating groove 3012 of the boss 301 and fixed to the output shaft end of the second motor 501, and the second gear a 502 is in engaged connection with the second gear b 3013.

During specific implementation, when the transmission assembly 50 drives the rotary disc 40 to rotate counterclockwise or clockwise within the inner frame 30 of the housing 10, the output shaft end of the second motor 501 drives the second gear a 502 to rotate counterclockwise or clockwise. When the second gear a 502 rotates, it drives the second gear b 3013 in the accommodating groove 3012 of the boss 301, so that the rotary disc 40 is driven to rotate counterclockwise or clockwise within the inner frame 30. When rotating, the second gear b 3013 is supported by the support bearing 30131 with the bottom end located in the bearing groove 30121. Moreover, when the second gear b 3013 rotates, the polygonal slot 30132 at the top end cooperates with the polygonal insertion rod 403 at the bottom end of the rotary disc 40, so that force is transferred to enable the second gear b 3013 to drive the rotary disc 40 to rotate. Additionally, when the rotary disc 40 rotates, the ring block 402 at the bottom end of the rotary disc rotates within the ring groove 3011 of the boss 301. Through such arrangement, the transmission assembly 50 can effectively drive the rotary disc 40 to rotate within the inner frame 30, so that the rotary disc 40 can carry and drive each can to move circumferentially.

Referring primarily to FIG. 14 and FIG. 16 to FIG. 24, in some embodiments, the can-opening assembly 60 includes a first bracket 601, a third motor 602, a third gear a 603, a third gear b 604, a third gear c 605, a third gear d 606, a third gear e 607, a third gear f 608, a third gear g 609, a third gear h 610, a rotator 611, a driven member 613, a displacement plate 614, a cutting blade 615, an abutting gear 616, and an edge-abutting plate 617. The third motor 602 is fixed on an inner side of the first bracket 601, the third gear a 603 is fixed at an output shaft end of the third motor 602, the third gear b 604 is rotatably arranged on the inner side of the first bracket 601, the third gear a 603 is in engaged connection with the third gear b 604, the third gear c 605 is fixed at a bottom end of the third gear b 604, the third gear d 606 is rotatably arranged on the inner side of the first bracket 601, and the third gear c 605 is in engaged connection with the third gear d 606. The third gear e 607 is fixed at a top end of the third gear d 606, the third gear f 608 is rotatably arranged on the inner side of the first bracket 601, the third gear e 607 is in engaged connection with the third gear f 608, the third gear g 609 is fixed at a top end of the third gear f 608, the third gear h 610 is rotatably arranged on the inner side of the first bracket 601, the third gear g 609 is in engaged connection with the third gear h 610, and a plurality of sleeve holes 6102 are annularly distributed in a bottom end of the third gear h 610. A top end of the rotator 611 is provided with an accommodating frame 6111, the abutting block 6112 is elastically connected in the accommodating frame 6111, the abutting block 6112 at the top end of the rotator 611 is correspondingly located in one of the sleeve holes 6102, one side of a top end of the abutting block 6112 is arranged as a slope surface 61121, and the other side of the top end of the abutting block is arranged as an inclined groove 61122. The inner side of the first bracket 601 is provided with a circular cavity 6013, one half of the circular cavity 6013 is a sector-shaped closed cavity 60131, and the other half of the circular cavity is a sector-shaped open cavity 60132. The rotator 611 is rotatably located in the circular cavity 6013, one end of the circular cavity 6013 within the sector-shaped open cavity 60132 is provided with a squeezing block 6014, and a front end of the squeezing block 6014 is arranged as an inclined surface 60141. The first bracket 601 is provided with a vertically-through hollow cylinder 6011 at a position correspondingly located in a middle part of the circular cavity 6013, and a bearing body 60111 is fixed in the hollow cylinder 6011. A bottom end of the rotator 611 has an eccentric wheel 612, the driven member 613 is located on the inner side of the first bracket 601, and one end of the driven member 613 is provided with an abutting hole 6131. The eccentric wheel 612 is correspondingly located in the abutting hole 6131 and abuts against an inner wall of the abutting hole 6131, a bottom end surface of the first bracket 601 is provided with a displacement-allowing groove 6012, and the displacement plate 614 is correspondingly located in the displacement-allowing groove 6012. A top end of the displacement plate 614 is provided with a ring edge 6141 extending to be located on the inner side of the first bracket 601, the other end of the driven member 613 is provided with a sleeve groove 6132 sleeving the ring edge 6141, the cutting blade 615 is rotatably arranged at a bottom end of the displacement plate 614, and a central shaft 6101 penetrating through the bearing body 60111, the rotator 611, the driven member 613, and the displacement plate 614 is fixed to a middle part of the third gear h 610. The abutting gear 616 is fixed at a bottom end of the central shaft 6101 and correspondingly located at the bottom end of the displacement plate 614, the edge-abutting plate 617 sleeves the central shaft 6101 and is correspondingly located between the displacement plate 614 and the abutting gear 616, and a bottom end of the edge-abutting plate 617 is provided with a cambered protruding edge 6171 in contact with a top end of the abutting gear 616.

During specific implementation, when the can-opening assembly 60 is going to open the can 2000 in one of the accommodating cavities 401, the first lifting assembly 70 lifts the can 2000 in the accommodating cavity 401 correspondingly located below the can-opening assembly 60, so that a ring wall 20001 at the top of the can 2000 is located between the abutting gear 616 and the cutting blade 615 of the can-opening assembly 60. Then, the third motor 602 is started to operate. When started to operate, the third motor 602 drives the third gear a 603 to rotate clockwise. When rotating, the third gear a 603 drives the third gear b 604. When rotating, the third gear b 604 drives the third gear c 605. When rotating, the third gear c 605 drives the third gear d 606. When rotating, the third gear d 606 drives the third gear e 607. When rotating, the third gear e 607 drives the third gear f 608. When rotating, the third gear f 608 drives the third gear g 609. When rotating, the third gear g 609 drives the third gear h 610 to rotate clockwise. When rotating clockwise, the third gear h 610 directly drives the rotator 611 to rotate clockwise and simultaneously drives the abutting gear 616 to rotate clockwise through the central shaft 6101. When rotating clockwise, the rotator 611 drives the eccentric wheel 612 to rotate clockwise. When rotating clockwise, the eccentric wheel 612 acts on the interior of the abutting hole 6131 at one end of the driven member 613 to drive the driven member 613 to tilt and displace to one side. Meanwhile, the sleeve groove 6132 at the other end of the driven member 613 acts on the ring edge 6141 of the displacement plate 614 to drive the displacement plate 614 to move linearly to the right. The displacement-allowing groove 6012 in the bottom end surface of the first bracket 601 provides a travel space for the displacement plate 614 to move linearly to the right. Since an elliptical hole 6142 in the displacement plate 614 allows the central shaft 6101 to penetrate through, and a diameter of the elliptical hole 6142 is greater than a diameter of the central shaft 6101, the elliptical hole 6142 does not affect the central shaft 6101 when the displacement plate 614 moves to the right. When moving to the right, the displacement plate 614 drives the cutting blade 615 to approach the abutting gear 616, so that the ring wall 20001 of the can 2000 is clamped between the cutting blade 615 and the abutting gear 616. Moreover, when the displacement plate 614 moves to the right in place, the inclined groove 61122 of the abutting block 6112 on the rotator 611 exactly makes contact with the inclined surface 60141 at the front end of the squeezing block 6014 in the sector-shaped open cavity 60132, so that the abutting block 6112 and the squeezing block 6014 generate a matching contact surface. The squeezing block 6014 can squeeze the abutting block 6112 downward, so as to reduce a depth of the abutting block 6112 located in the sleeve hole 6102 at the bottom end of the third gear h 610, so that the abutting block 6112 is only shallowly located in the sleeve hole 6102 at the bottom end of the third gear h 610. Thus, when the third gear h 610 rotates clockwise, the bottom end of the third gear h 610 can slide over the slope surface 61121 at the top end of the abutting block 6112, so that the third gear h 610 cannot drive the rotator 611 to continue rotating. However, the third gear h 610 drives the abutting gear 616 to continue rotating through the central shaft 6101. When rotating, the abutting gear 616 rotationally rubs the ring wall 20001 of the can 2000, so that the ring wall 20001 of the can 2000 is abutted to rotate between the cutting blade 615 and the abutting gear 616 by a friction force. As a result, the cutting blade 615 is also abutted to rotate by the rotation of the can 2000, thereby cutting the can lid of the can 2000. The cut can lid is clamped between the cutting blade 615 and the abutting gear 616. Then, the first lifting assembly 70 drives the can whose can lid has been cut to descend and be placed back into the accommodating cavity 401. Then, the transmission assembly 50 drives the rotary disc 40 to drive the can whose can lid has been cut to be rotationally transferred to the feeding hole 201 for the pet to eat. After the pet has eaten up the food in the can whose can lid has been cut, the transmission assembly 50 drives the rotary disc 40 to drive the empty can in the accommodating cavity 401 to be rotationally transferred to a position below the can-opening assembly 60. Then, the first lifting assembly 70 lifts the empty can in the accommodating cavity 401 to make contact with the can lid clamped between the cutting blade 615 and the abutting gear 616. Thereafter, the third motor 602 is started to operate. When started to operate, the third motor 602 drives the third gear a 603 to rotate counterclockwise. When rotating, the third gear a 603 drives the third gear b 604. When rotating, the third gear b 604 drives the third gear c 605. When rotating, the third gear c 605 drives the third gear d 606. When rotating, the third gear d 606 drives the third gear e 607. When rotating, the third gear e 607 drives the third gear f 608. When rotating, the third gear f 608 drives the third gear g 609. When rotating, the third gear g 609 drives the third gear h 610 to rotate counterclockwise. When the third gear h 610 rotates counterclockwise, the bottom end of the third gear h 610 counterclockwise abuts against the abutting block 6112 being squeezed by the squeezing block 6014 in the sector-shaped open cavity 60132, specifically abutting against the highest point part of the slope surface 61121 of the abutting block 6112, so that the abutting block 6112 displaces counterclockwise by the abutting force to disengage from the pressing of the squeezing block 6014. Then, the inclined groove 61122 of the abutting block 6112 disengages from the inclined surface 60141 of the squeezing block 6014. When the abutting block 6112 disengages from the squeezing block 6014, the abutting block 6112 resiliently pops up naturally within the accommodating frame 6111 to be deeply clamped into the sleeve hole 6102 at the bottom end of the third gear h 610, so that the rotator 611 can again be driven by the third gear h 610. At this time, the rotator 611 is driven by the third gear h 610 to rotate counterclockwise by a certain distance. Then, the rotator 611 drives the eccentric wheel 612 to rotate counterclockwise by a certain distance. When rotating counterclockwise, the eccentric wheel 612 acts on the interior of the abutting hole 6131 of the driven member 613 to drive the driven member 613 to tilt and displace to the other side. Meanwhile, the sleeve groove 6132 of the driven member 613 acts on the ring edge 6141 of the displacement plate 614 to drive the displacement plate 614 to move linearly to the left. The displacement-allowing groove 6012 in the bottom end surface of the first bracket 601 provides a travel space for the displacement plate 614 to move linearly to the left. When moving to the left, the displacement plate 614 drives the cutting blade 615 to move away from the abutting gear 616, so that the ring wall of the can lid disengages from the clamping between the cutting blade 615 and the abutting gear 616. Then, the can lid falls by inertia onto the top of the corresponding empty can below. Thereafter, the first lifting assembly 70 drives the empty can carrying the can lid to descend to be placed back into the accommodating cavity 401. Then, the transmission assembly 50 drives the rotary disc 40 to rotate counterclockwise to drive the empty can carrying the can lid in the accommodating cavity 401 to rotate downward. The edge-abutting plate 617 is configured to make contact with the top end of the ring wall 20001 of the can 2000, thereby preventing the first bracket 601 from directly making contact with the ring wall 20001 of the can 2000 and causing wear. The edge-abutting plate 617 sleeves the central shaft 6101 and is correspondingly located between the displacement plate 614 and the abutting gear 616. The edge-abutting plate 617 is in a stationary state relative to the central shaft 6101 and the abutting gear 616. The cambered protruding edge 6171 at the bottom end of the edge-abutting plate 617 makes contact with the top end of the abutting gear 616, so that the abutting gear 616 supports the edge-abutting plate 617 through contact with the cambered protruding edge 6171. However, when the abutting gear 616 makes contact with the cambered protruding edge 6171, there is no sufficient frictional force to drive the edge-abutting plate 617 to rotate. The top end of the edge-abutting plate 617 supports the displacement plate 614, and the displacement plate 614 may displace on the edge-abutting plate 617. Through such arrangement, the can-opening assembly 60 can effectively open the lid of the can 2000, effectively clamp the cut can lid of the can 2000, and effectively place the clamped can lid onto the empty can.

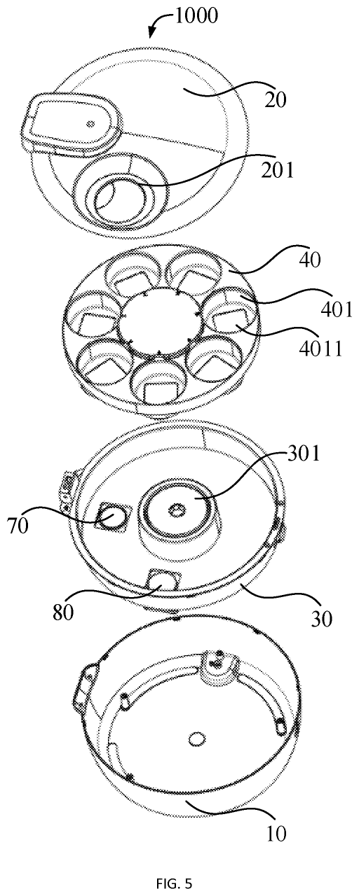

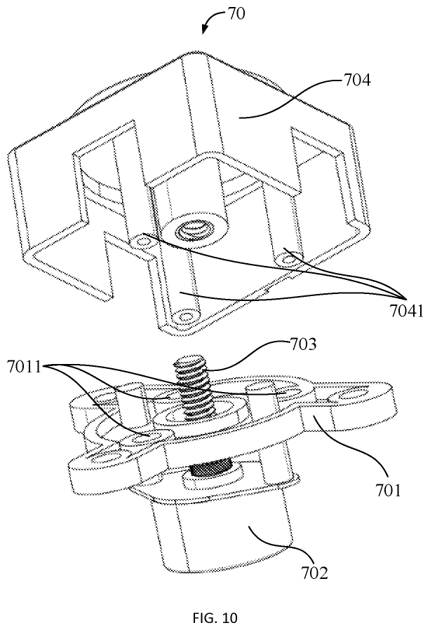

Referring primarily to FIG. 4, FIG. 5, FIG. 6, FIG. 9 and FIG. 10, in some embodiments, the first lifting assembly 70 includes a second bracket 701, a fourth motor 702, and a lifting base 704. The second bracket 701 is fixed on the bottom end surface of the inner frame 30, the fourth motor 702 is fixed at a bottom end of the second bracket 701, an output end of the fourth motor 702 has a first lead screw shaft 703, the lifting base 704 is in threaded connection with the first lead screw shaft 703, and the lifting base 704 penetrates through the inner frame 30 to correspond to the open hole 4011 at the bottom end of one of the accommodating cavities 401. A plurality of guide grooves 7011 are distributed in the second bracket 701, a plurality of guide columns 7041 are distributed on the lifting base 704, and each of the guide columns 7041 is movably located in the corresponding guide groove 7011.

During specific implementation, when the first lifting assembly 70 operates to drive the can in the accommodating cavity 401 of the rotary disc 40 to ascend for allowing the can-opening assembly 60 to open the lid, or drive the opened can to descend and be placed back into the accommodating cavity 401 of the rotary disc 40, the fourth motor 702 fixed on the second bracket 701 drives the first lead screw shaft 703 to rotate forward or reversely. When rotating forward or reversely, the first lead screw shaft 703 threadedly drives the lifting base 704 to ascend or descend. The guide columns 7041 of the lifting base 704 are respectively movably located in the guide grooves 7011 of the second bracket 701, so that the second bracket 701 provides vertical linear movement guidance for the lifting base 704. When ascending, the lifting base 704 can carry and drive the can in the accommodating cavity 401 of the rotary disc 40 to ascend for allowing the can-opening assembly 60 to open the lid. When descending, the lifting base 704 can carry and drive the opened can in the accommodating cavity 401 of the rotary disc 40 to be placed back into the accommodating cavity 401. Through such arrangement, the first lifting assembly 70 can effectively drive the can in the accommodating cavity 401 of the rotary disc 40 to ascend or descend.

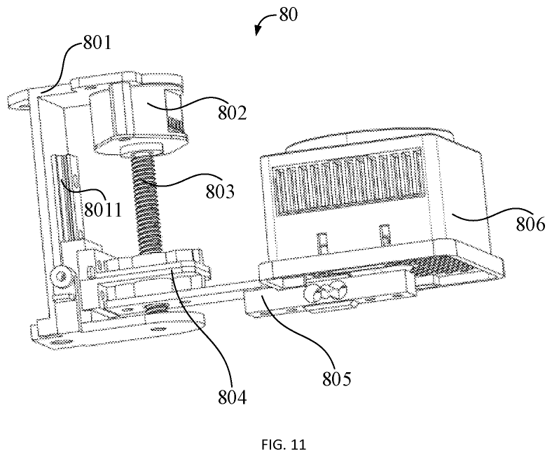

Referring primarily to FIG. 4, FIG. 5, FIG. 6 and FIG. 11, in some embodiments, the second lifting assembly 80 includes a third bracket 801, a fifth motor 802, a lifting platform 804, a weighing sensor 805, and a semiconductor refrigerator 806. The third bracket 801 is fixed on the bottom end surface of the inner frame 30, the fifth motor 802 is fixed onto the third bracket 801, an output end of the fifth motor 802 has a second lead screw shaft 803, the lifting platform 804 is in threaded connection with the second lead screw shaft 803, the third bracket 801 is provided with a slide rail 8011 corresponding to a side part of the lifting platform 804, and the lifting platform 804 is further slidably connected to the slide rail 8011. The weighing sensor 805 is fixed to the side part of the lifting platform 804, the semiconductor refrigerator 806 is fixed onto the weighing sensor 805, and the semiconductor refrigerator 806 penetrates through the inner frame 30 to correspond to the open hole 4011 at the bottom end of one of the accommodating cavities 401.

During specific implementation, when the second lifting assembly 80 operates to drive the opened can in the accommodating cavity 401 of the rotary disc 40 to ascend to correspond to the feeding hole 201 of the lid 20 for allowing the pet to eat, or drive the can with food inside eaten to descend in the accommodating cavity 401, the output end of the fifth motor 802 drives the second lead screw shaft 803 to rotate forward or reversely. When rotating forward or reversely, the second lead screw shaft 803 drives the lifting platform 804 to ascend or descend. When the lifting platform 804 moves up and down, the slide rail 8011 on the third bracket 801 provides vertical linear guidance. When ascending or descending, the lifting platform 804 drives the weighing sensor 805 to ascend or descend. When ascending or descending, the weighing sensor 805 drives the semiconductor refrigerator 806 to ascend or descend. Thus, when ascending, the semiconductor refrigerator 806 carries and drives the opened can in the accommodating cavity 401 to correspond to the feeding hole 201 of the lid 20 for allowing the pet to eat. When descending, the semiconductor refrigerator 806 carries and drives the can with food inside eaten in the accommodating cavity 401 to descend. The weighing sensor 805 is configured to weigh the can on the semiconductor refrigerator 806 to recognize whether canned food inside has been eaten up by the pet. Moreover, the semiconductor refrigerator 806 can generate cold energy which is transferred to the can with food that has not been eaten up, so as to keep the can with food that has not been eaten up fresh by cooling. Through such arrangement, the second lifting assembly 80 effectively drives the opened can in the accommodating cavity 401 to ascend, or drives the can with food inside eaten to descend. Moreover, the second lifting assembly 80 can effectively weigh the opened can to recognize whether the food in the can has been eaten up by the pet, and can also effectively keep the can with food that has not been eaten up fresh by cooling.

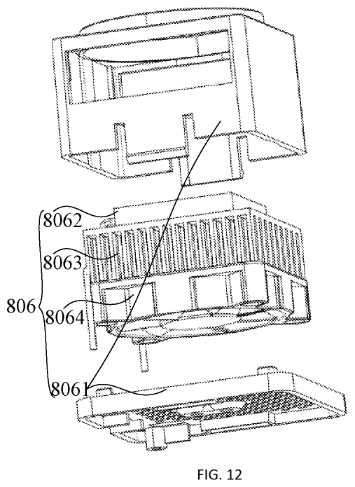

Referring primarily to FIG. 12, in some embodiments, the semiconductor refrigerator 806 includes a lifting frame 8061, a semiconductor refrigeration sheet 8062, heat dissipation fins 8063, and an electric fan 8064. The semiconductor refrigeration sheet 8062 is fixed on an inner top of the lifting frame 8061, the electric fan 8064 is fixed on an inner bottom of the lifting frame 8061, the heat dissipation fins 8063 are fixed between the semiconductor refrigeration sheet 8062 and the electric fan 8064, a top surface of the semiconductor refrigeration sheet 8062 is in contact with an inner top surface of the lifting frame 8061, and a ventilation hole corresponding to the electric fan 8064 is formed in a bottom end of the lifting frame 8061.

During specific implementation, when the semiconductor refrigerator 806 operates to keep the can with food that has not been eaten up fresh by cooling, the semiconductor refrigeration sheet 8062 is powered on to operate. When the semiconductor refrigeration sheet 8062 operates, its top end is a cold end and its bottom end is a hot end. The cold energy at the top end of the semiconductor refrigeration sheet 8062 is transferred to the inner top of the lifting frame 8061, and the top of the lifting frame 8061 carries the can. Thus, the semiconductor refrigeration sheet 8062 transfers the cold energy to the can through the top of the lifting frame 8061. The heat absorbed by the bottom end of the semiconductor refrigeration sheet 8062 is transferred to the heat dissipation fins 8063. The heat dissipation fins 8063 dissipate the heat over a wide area. The electric fan 8064 is configured to dissipate, by air, the heat on the heat dissipation fins 8063 to the outside from the ventilation hole at the bottom end of the lifting frame 8061. Through such arrangement, the semiconductor refrigerator 806 can effectively operate to keep the can with food that has not been eaten up on the second lifting assembly 80 fresh by cooling.

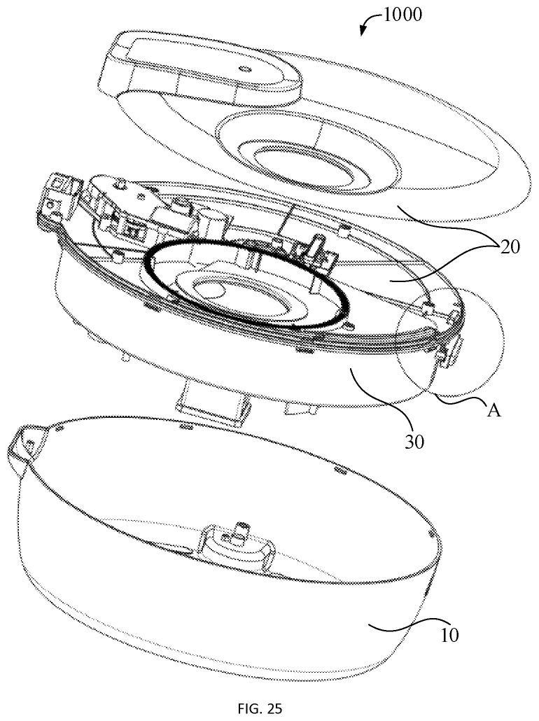

Referring primarily to FIG. 25 to FIG. 28, in some embodiments, one side of the lid 20 and one side of the housing 10 are connected by a rotating shaft, and a latch assembly 110 is arranged between the other side of the lid 20 and the other side of the housing 10. The latch assembly 110 includes a support post 1101, a spring 1102, a push button 1103, a buckle plate 1104, and guide rods 1105. The support post 1101 is fixed on an outer surface part of the inner frame 30, the spring 1102 is fixed on the outer surface part of the inner frame 30 and surrounds the support post 1101, the push button 1103 is fixed on the spring 1102 and extends to be located on an outer surface part of the housing 10, the buckle plate 1104 is integrally formed at a top end of the push button 1103, and a buckle wall 11041 is arranged on one side of a top end of the buckle plate 1104. The lid 20 is internally provided with a movement-allowing groove 202, a side part of the movement-allowing groove 202 is provided with an opening 2021, the top end of the buckle plate 1104 extends to be located in the movement-allowing groove 202, and the buckle wall 11041 at the top end of the buckle plate 1104 corresponds to the opening 2021. Two guide rods 1105 are provided, the two guide rods 1105 are symmetrically arranged on the outer surface part of the inner frame 30, two sides of the push button 1103 are both provided with arc-shaped grooves 11031, and the arc-shaped grooves 11031 in the two sides of the push button 1103 respectively accommodate the two guide rods 1105.

During specific implementation, when it is necessary to open the lid 20 on the housing 10 via the latch assembly 110, the user may press the push button 1103 extending to be located on the outer surface part of the housing 10. When the push button 1103 is pressed, the push button compresses the spring 1102 sleeving the support post 1101. At this time, the push button 1103 and the buckle plate 1104 move forward together. When moving forward, the buckle plate 1104 drives the buckle wall 11041 at the top end to enter the movement-allowing groove 202 from the outside of the opening 2021 of the movement-allowing groove 202. Thus, the buckle plate 1104 releases the pressing and buckling on the lid 20, and the lid 20 is unlocked, allowing the user to open the lid 20 on the housing 10. When it is necessary to close the lid 20 on the housing 10 via the latch assembly 110, the user presses the push button 1103 without releasing it, so that the push button 1103 drives the buckle wall 11041 at the top end of the buckle plate 1104 to enter the movement-allowing groove 202 from the outside of the opening 2021 of the movement-allowing groove 202. Then, the housing 10 is covered with the lid 20. At this time, the user releases the push button 1103. The push button 1103 is then driven by the rebound of the spring 1102, so that the push button 1103 moves backward to drive the buckle wall 11041 at the top end of the buckle plate 1104 to move from inside the movement-allowing groove 202, penetrating through the opening 2021, to the outside of the opening 2021, thereby clamping and abutting against the lid 20 to achieve latching of the lid 20. Through such arrangement, the lid 20 can be opened and closed by the user's operation.

The basic principles, main features, and advantages of the present disclosure have been shown and described above. It will be apparent to those skilled in the art that the present disclosure is not limited to the details of the above exemplary embodiments, and that the present disclosure may be implemented in other specific forms without departing from the spirit or essential characteristics of the present disclosure. Therefore, the embodiments are to be regarded in all respects as illustrative and not restrictive. The scope of the present disclosure is defined by the appended claims rather than by the foregoing description. Consequently, all changes that fall within the meaning and range of equivalents of the claims are intended to be encompassed by the present disclosure. No reference numeral in the claims should be construed as limiting the claim concerned.

Furthermore, it should be understood that although this specification is described in terms of implementations, not every implementation contains only a single independent technical solution. This manner of description of this specification is merely for the sake of clarity. This specification should be considered as a whole by a person skilled in the art, and the technical solutions in various embodiments may also be properly combined, to form other implementations that can be understood by the person skilled in the art.

What is claimed is:

1. A rotary disc feeder, comprising a housing, a lid, a rotary disc, a transmission assembly, a can-opening assembly, a first lifting assembly, a second lifting assembly, and an opening-closing assembly, wherein
the lid is arranged on the housing in a manner of being openable and closable, the rotary disc is rotatably arranged in the housing and provided with a plurality of accommodating cavities each having an open hole at a bottom end, and the lid is provided with a feeding hole corresponding to a top end of one of the accommodating cavities; the transmission assembly is arranged in the housing and is in transmission connection with the rotary disc, and the can-opening assembly is arranged in the lid and extends on a bottom end surface of the lid to correspond to the top end of one of the accommodating cavities; and the first lifting assembly is arranged in the housing and correspondingly located at a bottom end of the rotary disc, the second lifting assembly is arranged in the housing and correspondingly located at the bottom end of the rotary disc, and the opening-closing assembly is arranged on the lid and configured to cover or expose the feeding hole in the lid.

2. The rotary disc feeder according to claim 1, further comprising an RFID sensing assembly, wherein the RFID sensing assembly is arranged in the lid and comprises a processing circuit board and an RFID sensing coil, and the processing circuit board is electrically connected to the RFID sensing coil.

3. The rotary disc feeder according to claim 1, wherein the opening-closing assembly is arranged in the lid and extends on the bottom end surface of the lid to correspond to the feeding hole, and the opening-closing assembly comprises a first motor, a first gear a, a support plate, a rotating shaft, a first gear b, and a baffle plate; the first motor is fixed in the lid, the first gear a is connected to an output end of the first motor and rotatably arranged in the lid, the support plate is fixed in the lid, and the rotating shaft is rotatably connected to a bottom end of the support plate; and the first gear b and the rotating shaft are integrally formed, the first gear a is in engaged connection with the first gear b, the baffle plate is in screwed connection with a bottom end of the rotating shaft and is located on the bottom end surface of the lid, the baffle plate corresponds to the feeding hole in the lid, and a side part of the baffle plate is provided with a soft rubber portion.

4. The rotary disc feeder according to claim 1, wherein the housing has an inner frame inside, the rotary disc is rotatably arranged in the inner frame, and the transmission assembly, the first lifting assembly, and the second lifting assembly are distributed and fixed on a bottom end surface of the inner frame.

5. The rotary disc feeder according to claim 4, wherein a top end of the inner frame has a boss, the boss is provided with a ring groove, the bottom end of the rotary disc has a ring block, and the ring block at the bottom end of the rotary disc is movably located in the ring groove of the boss; the boss is internally provided with an accommodating groove, the boss is provided with a bearing groove within the accommodating groove, the accommodating groove has a second gear b inside, a bottom end of the second gear b is equipped with a support bearing, and the support bearing at the bottom end of the second gear b is correspondingly located in the bearing groove; a top end of the second gear b is provided with a polygonal slot, the polygonal slot is exposed on an outer surface part of the boss, the bottom end of the rotary disc is provided with a polygonal insertion rod, and the polygonal insertion rod at the bottom end of the rotary disc is inserted into the polygonal slot at the top end of the second gear b; and the transmission assembly comprises a second motor and a second gear a, the second motor is fixed on the bottom end surface of the inner frame, an output shaft end of the second motor extends to be located in the accommodating groove of the boss, the second gear a is located in the accommodating groove of the boss and fixed to the output shaft end of the second motor, and the second gear a is in engaged connection with the second gear b.

6. The rotary disc feeder according to claim 1, wherein the can-opening assembly comprises a first bracket, a third motor, a third gear a, a third gear b, a third gear c, a third gear d, a third gear e, a third gear f, a third gear g, a third gear h, a rotator, a driven member, a displacement plate, a cutting blade, an abutting gear, and an edge-abutting plate; the third motor is fixed on an inner side of the first bracket, the third gear a is fixed at an output shaft end of the third motor, the third gear b is rotatably arranged on the inner side of the first bracket, the third gear a is in engaged connection with the third gear b, the third gear c is fixed at a bottom end of the third gear b, the third gear d is rotatably arranged on the inner side of the first bracket, and the third gear c is in engaged connection with the third gear d; the third gear e is fixed at a top end of the third gear d, the third gear f is rotatably arranged on the inner side of the first bracket, the third gear e is in engaged connection with the third gear f, the third gear g is fixed at a top end of the third gear f, the third gear h is rotatably arranged on the inner side of the first bracket, the third gear g is in engaged connection with the third gear h, and a plurality of sleeve holes are annularly distributed in a bottom end of the third gear h; a top end of the rotator is provided with an accommodating frame, the abutting block is elastically connected in the accommodating frame, the abutting block at the top end of the rotator is correspondingly located in one of the sleeve holes, one side of a top end of the abutting block is arranged as a slope surface, and the other side of the top end of the abutting block is arranged as an inclined groove; the inner side of the first bracket is provided with a circular cavity, one half of the circular cavity is a sector-shaped closed cavity, and the other half of the circular cavity is a sector-shaped open cavity; the rotator is rotatably located in the circular cavity, one end of the circular cavity within the sector-shaped open cavity is provided with a squeezing block, a front end of the squeezing block is arranged as an inclined surface, the first bracket is provided with a vertically-through hollow cylinder at a position correspondingly located in a middle part of the circular cavity, a bearing body is fixed in the hollow cylinder, a bottom end of the rotator has an eccentric wheel, the driven member is located on the inner side of the first bracket, and one end of the driven member is provided with an abutting hole; the eccentric wheel is correspondingly located in the abutting hole and abuts against an inner wall of the abutting hole, a bottom end surface of the first bracket is provided with a displacement-allowing groove, and the displacement plate is correspondingly located in the displacement-allowing groove; a top end of the displacement plate is provided with a ring edge extending to be located on the inner side of the first bracket, the other end of the driven member is provided with a sleeve groove sleeving the ring edge, the cutting blade is rotatably arranged at a bottom end of the displacement plate, and a central shaft penetrating through the bearing body, the rotator, the driven member, and the displacement plate is fixed to a middle part of the third gear h; and the abutting gear is fixed at a bottom end of the central shaft and is correspondingly located at the bottom end of the displacement plate, the edge-abutting plate sleeves the central shaft and is correspondingly located between the displacement plate and the abutting gear, and a bottom end of the edge-abutting plate is provided with a cambered protruding edge in contact with a top end of the abutting gear.

7. The rotary disc feeder according to claim 4, wherein the first lifting assembly comprises a second bracket, a fourth motor, and a lifting base, the second bracket is fixed on the bottom end surface of the inner frame, the fourth motor is fixed at a bottom end of the second bracket, an output end of the fourth motor has a first lead screw shaft, the lifting base is in threaded connection with the first lead screw shaft, the lifting base penetrates through the inner frame to correspond to the open hole at the bottom end of one of the accommodating cavities, a plurality of guide grooves are distributed in the second bracket, a plurality of guide columns are distributed on the lifting base, and each of the guide columns is movably located in the corresponding guide groove.

8. The rotary disc feeder according to claim 4, wherein the second lifting assembly comprises a third bracket, a fifth motor, a lifting platform, a weighing sensor, and a semiconductor refrigerator; and the third bracket is fixed on the bottom end surface of the inner frame, the fifth motor is fixed onto the third bracket, an output end of the fifth motor has a second lead screw shaft, the lifting platform is in threaded connection with the second lead screw shaft, the third bracket is provided with a slide rail corresponding to a side part of the lifting platform, the lifting platform is further slidably connected to the slide rail, the weighing sensor is fixed to the side part of the lifting platform, the semiconductor refrigerator is fixed onto the weighing sensor, and the semiconductor refrigerator penetrates through the inner frame to correspond to the open hole at the bottom end of one of the accommodating cavities.

9. The rotary disc feeder according to claim 8, wherein the semiconductor refrigerator comprises a lifting frame, a semiconductor refrigeration sheet, a heat dissipation fin, and an electric fan; and the semiconductor refrigeration sheet is fixed on an inner top of the lifting frame, the electric fan is fixed on an inner bottom of the lifting frame, the heat dissipation fin is fixed between the semiconductor refrigeration sheet and the electric fan, a top surface of the semiconductor refrigeration sheet is in contact with an inner top surface of the lifting frame, and a ventilation hole corresponding to the electric fan is formed in a bottom end of the lifting frame.

10. The rotary disc feeder according to claim 1, wherein one side of the lid and one side of the housing are connected by a rotating shaft, and a latch assembly is arranged between the other side of the lid and the other side of the housing; the latch assembly comprises a support post, a spring, a push button, a buckle plate, and guide rods; the support post is fixed on an outer surface part of the inner frame, the spring is fixed on the outer surface part of the inner frame and surrounds the support post, the push button is fixed on the spring and extends to be located on an outer surface part of the housing, the buckle plate is integrally formed at a top end of the push button, and a buckle wall is arranged on one side of a top end of the buckle plate; the lid is internally provided with a movement-allowing groove, a side part of the movement-allowing groove is provided with an opening, the top end of the buckle plate extends to be located in the movement-allowing groove, and the buckle wall at the top end of the buckle plate corresponds to the opening; and two guide rods are provided, the two guide rods are symmetrically arranged on the outer surface part of the inner frame, two sides of the push button are both provided with arc-shaped grooves, and the arc-shaped grooves in the two sides of the push button respectively accommodate the two guide rods.
